(19) United States
(12) Patent Application Publication
(10) Pub. No.: US 2018/0198666 A1
(43) Pub. Date: Jul. 12, 2018

(54) TRANSMISSION OF SYSTEM INFORMATION

(71) Applicant: Telefonaktiebolaget LM Ericsson (publ), Stockholm (SE)

(72) Inventors: Jianfeng WANG, Beijing (CN); Jinhua LIU, Beijing (CN); Yanli ZHENG, Beijing (CN)

(73) Assignee: Telefonaktiebolaget LM Ericsson (publ), Stockholm (SE)

(21) Appl. No.: 15/514,950

(22) PCT Filed: Apr. 22, 2016
(86) PCT No.: PCT/CN2016/079987

§ 371 Date: Mar. 28, 2017

(51) Int. Cl. H04L 27/26; H04L 5/00

(52) U.S. Cl. CPC H04L 27/2662; H04L 5/0053; H04W 48/12; H04L 27/2692; H04L 5/0094

(57) ABSTRACT

The embodiments disclose a method for a wireless node, which comprises determining a transmission block, according to a payload of the system information, determining one or more reference sequences from a predefined sequence set according to the transmission block, the one or more reference sequences indicating time and frequency resource grid of the determined transmission block and transmitting the system information and the one or more reference sequences in the determined transmission block. The embodiments also disclose a method for a communication device, which comprises detecting at least one set of one or more reference sequences, each set of the one or more reference sequences from a predefined sequence set indicating time and frequency resource grid of a transmission block for system information; determining at least one transmission block for the system information according to the detected at least one set of the one or more reference sequences; and decoding the system information in the determined at least one transmission block. The wireless node and communication devices thereof are also presented.

### TECHNICAL FIELD

The present disclosure generally relates to methods for transmitting system information of communication networks and wireless nodes and communication devices thereof.

### BACKGROUND

In the fifth generation (5G) communication networks, a concept of access information table (AIT) for system information is introduced, which is designed to include all possible parameter combinations of all wireless nodes to support all possible access configurations and system parameters. The AIT comprises a number of entries, which indicate configuration parameters related to the access control, such as random access, paging, handover, and reselection procedures, and advanced settings, such as beam-forming, link adaptation and Hybrid Automatic Repeat Request (HARQ). The more entries in the AIT mean the more flexibility for the initial random access configurations in coverage of the communication networks, and also the higher random access successful rate for communication devices.

To transmit AIT to communication devices and facilitate the detection of the AIT for communication devices, a format of the AIT may be predefined and fixed for the wireless nodes and communication devices. However, a number of entries and payload size of the AIT for communication networks may vary in different application scenarios and different networking configurations. For example, an indoor communication system could be shared by multiple telecommunication operators; therefore, multiple entries of corresponding Public Land Mobile Networks (PLMN) should be included in the AIT. For another example, if a wireless node with multiple antennas intends to coverage a large area, narrower beams should be used, which means a large number of beams shall be used. Therefore, more system information for the configuration of beams should be included in the AIT, resulting in a larger payload size of the AIT.

Therefore, a fixed transmission format for system information e.g., the AIT limits the possibility to adapt the transmission of system information to different application scenarios and different networking configurations. In order to facilitate different transmission formats of the system information (e.g., the AIT), extra control information indicating different transmission formats of the system information may be required, such as Radio Resource Control (RRC) signalling, broadcast signalling, and downlink control indicator (DCI) on physical downlink control channel (PDCCH) in Long Term Evolution (LTE) wireless communication systems of the 3^{rd} generation partnership project (3GPP), in turn leading to more overhead for control signaling.

### SUMMARY

In this disclosure, a method to enable system information transmission with flexible transmission block size without extra control information is present. Generally speaking, one or more reference sequences indicating time and frequency resource grid of different transmission block size of the system information, are inserted into the transmission of system information, which could be organized into a sequence of subframes between wireless node and communication devices. The reference sequences could be also used for time and/or frequency synchronization and channel estimation for communication devices. It should be noted that no extra control information or control signaling is required for the transmission of system information with flexible transmission block size. The communication devices could detect the reference sequences, and the transmission block of the system information could be determined according to the detected reference sequences, and then the system information could be decoded in the determined transmission block by the communication devices.

According to one aspect of the disclosure, there is provided a method for a wireless node transmitting system information in communication networks, and the method comprises determining a transmission block, according to a payload of the system information; determining one or more reference sequences from a predefined sequence set according to the determined transmission block, the one or more reference sequences indicating time and frequency resource grid of the determined transmission block and transmitting the system information and the one or more reference sequences in the determined transmission block.

According to another aspect of the disclosure, the determined transmission block comprises one or more subframe groups and a plurality of subcarriers, the one or more reference sequences correspond to the one or more subframe groups of the determined transmission block, and each reference sequence of the one or more reference sequences is transmitted on the plurality of subcarriers of a predefined symbol in the corresponding subframe group.

According to another aspect of the disclosure, the determined transmission block comprises one or more subframe groups and a plurality of subcarriers, and the determined reference sequences from the predefined sequence set comprises a starting reference sequence, a middle reference sequence and an ending reference sequence, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups, and each reference sequence of the one or more reference sequences is transmitted on the plurality of subcarriers of a predefined symbol in the corresponding subframe group.

According to another aspect of the disclosure, there is provided a method for a communication device receiving system information in communication networks, and the method comprises detecting at least one set of one or more reference sequences, each set of the one or more reference sequences from a predefined sequence set indicating time and frequency resource grid of a transmission block for system information; determining at least one transmission block for the system information according to the detected at least one set of the one or more reference sequences; and decoding the system information in the determined at least one transmission block.

According to another aspect of the disclosure, if detecting more than one set of one or more reference sequences, the method further comprises a step of combining the determined more than one transmission block and a step of decoding the system information in the combined transmission block.

According to another aspect of the disclosure, the step of detecting at least one set of one or more reference sequences further comprises detecting at least one set of one or more reference sequence on a plurality of subcarriers of at least one set of one or more predefined symbols in corresponding at least one set of one or more subframe groups of the transmission block, and the at least one set of one or more reference sequences corresponds to the at least one set of one or more subframe groups of the transmission block.

According to another aspect of the disclosure, the step of detecting at least one set of one or more reference sequences further comprises detecting at least one set of a starting reference sequence, a middle reference sequence and an ending reference sequence on a plurality of subcarriers of at least one set of one or more predefined symbols in corresponding at least one set of one or more subframe groups of the transmission block, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups.

According to another aspect of the disclosure, there is provided a wireless node for communication networks, and the wireless node comprises a transmission block determination module configured to determine a transmission block, according to a payload of the system information, a reference sequence determination module configured to determine one or more reference sequences from a predefined sequence set according to the determined transmission block, the one or more reference sequences indicating time and frequency resource grid of the determined transmission block; and a transmission module configured to transmit the system information and the one or more reference sequences in the determined transmission block.

According to another aspect of the disclosure, there is provided a wireless node for communication networks, and the wireless node comprises a first interface configured to interact with communication devices, a second interface configured to interact with core networks, a memory configured to store data and instructions and a processing system, configured to execute the instructions performing the steps of any one of the aforementioned methods for the wireless node.

According to another aspect of the disclosure, there is provided a computer readable storage medium, which store instructions which, when run on a wireless node, cause the wireless node to perform the steps of any one of the aforementioned methods for the wireless node.

According to another aspect of the disclosure, there is provided a communication device operable in communication networks, and the communication device comprises a detection module configured to detect at least one set of one or more reference sequences, each set of the one or more reference sequences from a predefined sequence set indicating time and frequency resource grid of a transmission block for system information, a determination module configured to determine at least one transmission block for the system information according to the detected at least one set of the one or more reference sequences and a decoding module configured to decode the system information in the determined at least one transmission block.

According to another aspect of the disclosure, there is provided a communication device operable in communication networks, and the communication device comprises a first interface configured to interact with communication networks, a memory configured to store data and instructions therein and a processing system, configured to execute the instructions performing the steps of any one of the aforementioned methods for the communication device.

According to another aspect of the disclosure, there is provided a computer readable storage medium, which store instructions which, when run on a communication device, cause the communication device to perform the steps of any one of the aforementioned methods for the communication device.

### BRIEF DESCRIPTION OF THE DRAWINGS

The disclosure will now be described, by way of example, based on embodiments with reference to the accompanying drawings, wherein:

FIG. 1 shows a flowchart for illustrating a method of transmitting system information to communication device with flexible transmission blocks according to an embodiment of the disclosure.

FIG. 2 schematically illustrates an exemplary configuration of transmission block and reference sequences for system information according to an embodiment of the disclosure.

FIG. 3 schematically illustrates another exemplary configuration of transmission block and reference sequences for system information according to an embodiment of the disclosure.

FIG. 4 shows a flowchart for illustrating a method of receiving system information from wireless nodes with flexible transmission blocks according to an embodiment of the disclosure.

FIG. 5 shows a flowchart for illustrating another method of receiving system information from wireless nodes with flexible transmission blocks according to an embodiment of the disclosure.

FIG. 6 schematically illustrates a block diagram of a wireless node according to an embodiment of the disclosure.

FIG. 7 schematically illustrates another block diagram of a wireless node according to an embodiment of the disclosure.

FIG. 8 schematically illustrates a block diagram of a communication device according to an embodiment of the disclosure.

FIG. 9 schematically illustrates another block diagram of a communication device according to an embodiment of the disclosure.

FIG. 10 schematically illustrates another block diagram of a communication device according to an embodiment of the disclosure.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

The present technology is described below with reference to block diagrams and/or flowchart illustrations of methods, nodes, devices (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program product on a computer-usable or computer-readable storage medium having computer-usable or computer-readable program code embodied in the medium for use by or in connection with an instruction execution system. In the context of this disclosure, a computer-usable or computer-readable medium may be any medium that may contain, store, communicate, propagate, or transport the program for use by or in connection with the instruction execution system, apparatus, or device.

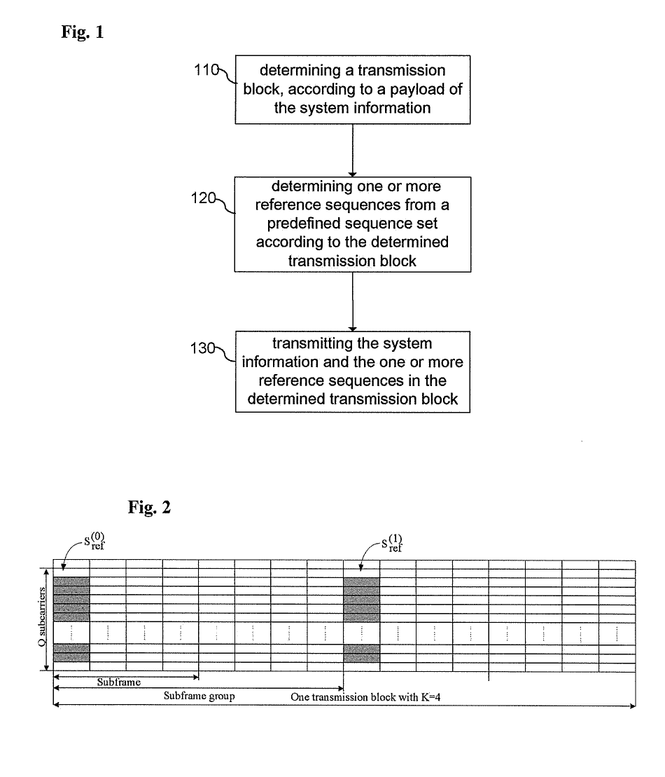

FIG. 1 shows a flowchart for illustrating a method of transmitting system information to communication device with flexible transmission blocks according to an embodiment of the disclosure. The payload size of system information could be determined according to a plurality of factors, such as a number of wireless nodes for communication networks, and different configuration parameters related to the access control, such as random access, paging, handover, and reselection procedures, and advanced settings, such as beam-forming, link adaptation and HARQ. Therefore, different transmission block sizes should be used according to different payload of the system information. Since a transmission between wireless node and communication devices is organized into a sequence of subframes in time domain and a plurality of subcarriers in frequency domain, therefore, for a given number of subcarriers, the transmission block size could be represented by the number of subframes. The number for subcarriers and the mapping relationship between the payload size of system information and the number of subframes could be preconfigured for the wireless node, for example.

At step 110, a wireless node determines a transmission block, according to a payload of system information. As aforementioned, for a given number of subcarrier in the frequency domain, such as Q, the determination could be based on the mapping relationship between the payload of the system information and the number of subframes, which could be preconfigured for the wireless nodes for example. An exemplary mapping table between the number of subframs (K) and the size of system information is shown in Table.1, which can also be expressed as a mathematical expression, such as payload size of system information=50× K. It should be mentioned that Table.1 is illustrated only for exemplary purpose, and those skilled in the art could design specific mapping relationships between the payload size of system information and the number of subframes without departing the spirit of this disclosure. Furthermore, the mapping relationship could depend on modulation and coding (MCS) scheme for the payload of system information and other factors, such as channel condition, networking configurations and specific application scenarios. According to the mapping relationships, the wireless node could determine a transmission block, which could be represented as time and frequency resource grid, e.g., a number of subframes and a number of subcarriers in orthogonal frequency division multiplexing (OFDM) based communication systems.

TABLE 1
An exemplary mapping table between the number of
subframs (K) and the size of system information

| | Payload size of system |
|---|---|
| Number of subframes (K) | information (bits) |
| 2 | 100 |
| 4 | 200 |
| 6 | 300 |
| 8 | 400 |
| . . . | . . . |

At step 120, the wireless node determines one or more reference sequences from a predefined sequence set according to the determined transmission block, and the one or more reference sequences indicates the time and frequency resource grid of the determined transmission block. It should be mentioned that the predefined sequence set could be preconfigured for the wireless node and communication devices, and a time and frequency transmission pattern of the one or more reference sequences implicitly indicate the physical layer transmission configuration of the determined transmission block, which could be used for communication devices to determine the transmission block and decode the system information in the transmission block. In other words, the pattern of the one or more reference sequences is an arrangement of the one or more reference sequences with respect to the transmission block in time and frequency domain, which could be exploited by the communication devices to determine the transmission block and thus decode the system information in the transmission block. Two exemplary configurations of the transmission block and reference sequences are illustrated in FIG. 2 and FIG. 3 as discussed below, each of which shows an specific transmission pattern for the one or more reference sequences and the transmission block for system information. Therefore, from this approach, it is not necessary for the wireless node to explicitly notify the communication devices the transmission block in the time and frequency domain, instead, the pattern of the one or more reference sequences implicitly indicate a configuration of the transmission block in the time and frequency domain. Therefore, no extra signalling from wireless nodes to communication devices, such as RRC signalling and DCI on PDCCH, is not required, thereby increasing transmission efficiency of system information for wireless node in communication networks.

At step 130, the wireless node transmits to communication devices the system information and the one or more reference sequences in the determined transmission block. It could be appreciated by the person skilled in the art that the transmission of system information to communication device could be broadcasting, multicasting or unicasting, according to different application scenarios and network configurations. It is also desirable that the transmission of system information could be periodic.

FIG. 2 schematically illustrates an exemplary configuration of transmission block and reference sequences for system information according to an embodiment of the disclosure. As illustrated, the transmission between the wireless node and communication devices is organized into a sequence of subframes in time domain and a plurality of subcarriers in frequency domain, which is applicable for both OFDM and other non-orthogonal frequency domain multiplexing schemes, such as Non-orthogonal Multiple Access (NOMA) in 5G systems. The subframes could be further grouped into a plurality of subframe groups, and the number of subframes in each subframe group could be preconfigured for the wireless nodes, e.g., two subframes in each group as illustrated in FIG. 2. There is a plurality of symbols in each subframe. For example, according to an exemplary payload size of system information, the number of subframes in the transmission block (K) could be four and there are four symbols in each subframe, which is illustrated in FIG. 2 only for exemplary purpose. A reference sequence, S_{ref}⁽ⁱ⁾ which is used to indicate the ith subframe group, is selected from a predefined sequence set. As for a configuration in FIG. 2, there are only two reference sequences determined according to the transmission block with four subframes (i.e., two subframe groups), i.e., S_{ref}⁽⁰⁾ and S_{ref}⁽¹⁾, and the number of contiguous subcarriers used for the transmission block in frequency domain is Q. It should be mentioned that the predefined sequence set could be preconfigured for both the wireless node and communication devices operable in communication networks. The sequences with good auto-correlation property, such as Zadoff Chu (ZC) sequences could be used for the reference sequence in this disclosure.

As discussed, without departing a spirit of the disclosure, a transmission block comprises one or more subframe groups and a plurality of subcarriers, and the one or more reference sequences corresponds to the one or more subframe groups of the determined transmission block, and each reference sequence of the one or more reference sequences is transmitted on the plurality of subcarriers of a predefined symbol in the corresponding subframe group. In FIG. 2, for instance, two reference sequences, S_{ref}⁽⁰⁾ and S_{ref}⁽¹⁾ are transmitted in the first symbol in corresponding two subframe groups. It will be appreciated by the skilled in the art that the predefined symbols used to transmit the reference sequences should be preconfigured for both wireless node and communication devices and they could be other symbols than the first symbol in each subframe group, without departing the spirit of the disclosure.

FIG. 3 schematically illustrates another exemplary configuration of transmission block and reference sequences for system information according to an embodiment of the disclosure. As illustrated, there are eight subframes in a specific transmission block, which is determined according to a payload of system information for example, i.e., K=8. For instance, each subframe group comprises two subframes, and there are two symbols in each subframe. The number of subcarriers used to transmit reference sequence could be Q, as illustrated in FIG. 3. Different from the configuration in FIG. 2, there could be only three kinds of reference sequence in the reference set, which are defined as a starting sequence, S_{ref}^{(start)}, a middle sequence, S_{ref}^{(mid)} and an ending sequence, S_{ref}^{(end)}.

The starting reference sequence corresponds to a first subframe group of the one or more subframe groups, the ending reference sequence corresponds to a last subframe group of the one or more subframe groups, and the middle reference sequence corresponds to other subframe groups of the one or more subframe groups than the first subframe group and the last subframe group of the one or more subframe groups. Each reference sequence of the one or more reference sequences is transmitted on the plurality of subcarriers of a predefined symbol in the corresponding subframe group. In FIG. 2, the starting reference sequences, S_{ref}^{(start)} is transmitted in the first symbol of the first subframe group, two middle reference sequences S_{ref}^{(mid)} are transmitted in the first symbol in the second and the third subframe groups, and the ending reference sequences S_{ref}^{(end)} is transmitted in the first symbol in the fourth subframe groups. It will be appreciated by the skilled in the art that the predefined symbols used to transmit the reference sequence could be preconfigured for wireless node and/or communication devices and they could be other symbols than the first symbol in each subframe group, without departing the spirit of the disclosure.

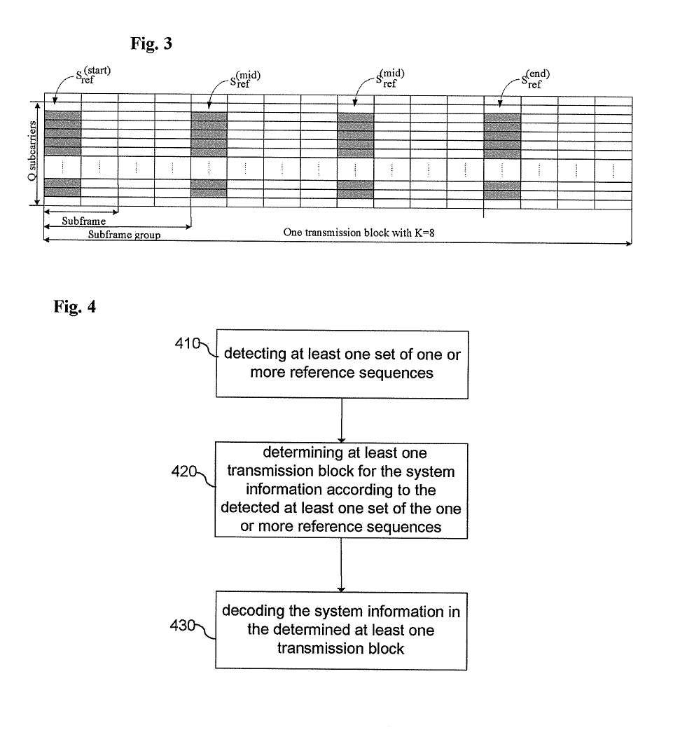

FIG. 4 shows a flowchart for illustrating a method of receiving system information from wireless nodes with flexible transmission blocks according to an embodiment of the disclosure. As aforementioned, a transmission of system information between the wireless node and communication devices could be periodic, therefore, the communication device could use one or more periodic transmission blocks to decode the system information, which could depend on channel quality, application scenario and specific decoding algorithms used by communication devices.

At step 410, a communication device detects at least one set of one or more reference sequences, and each set of the one or more reference sequences from a predefined sequence set indicates time and frequency resource grid of a transmission block for system information. For instance, the communication device could employ a match filter process and other blind or semi-blind detecting algorithms to detect which reference sequence in a predefined sequence set is transmitted from the wireless node. For one example, with respect to the reference sequence and transmission block configuration in FIG. 2, the communication device could detect at least one set of one or more reference sequence on a plurality of subcarriers of at least one set of one or more predefined symbols in corresponding at least one set of one or more subframe groups of the transmission block, and the at least one set of one or more reference sequences corresponds to the at least one set of one or more subframe groups of the transmission block.

For another example, with respect to the reference sequence and transmission block configuration in FIG. 3, the communication device detects at least one set of a starting reference sequence, a middle reference sequence and an ending reference sequence on a plurality of subcarriers of at least one set of one or more predefined symbols in corresponding at least one set of one or more subframe groups of the transmission block, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups.

At step 420, the communication device determines at least one transmission block for the system information according to the detected at least one set of the one or more reference sequences. As aforementioned, one or more reference sequences indicate the time and frequency resource grid for the transmission block of the system information, as illustrated in FIG. 2 or FIG. 3 for example. Therefore, once the communication device detects at least one set of one ore more reference sequence, the communication device could determine at least one transmission block itself, since the configuration of reference sequence and transmission block could be preconfigured by the wireless node and communication devices, for example as illustrated in FIG. 2 and FIG. 3.

At step 430, the communication device decodes the system information in the determined at least one transmission block. It will be desirable for the skilled in the art that specific decoding algorithms could be used in the communication devices, such as maximum a posteriori (MAP) decoding algorithm or an iterative Turbo decoding algorithm, without departing the spirit of this disclosure.

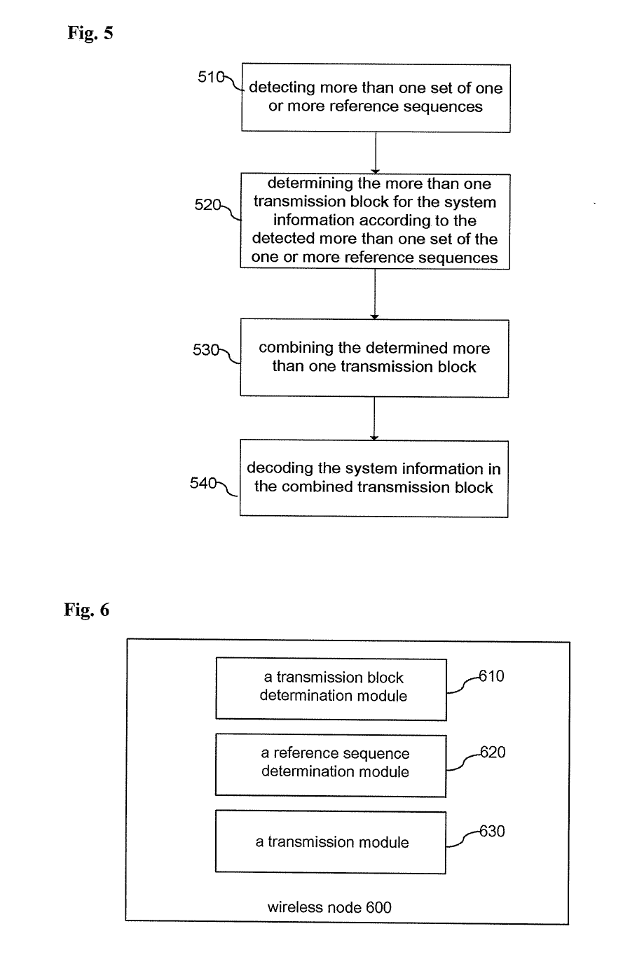

FIG. 5 shows a flowchart for illustrating another method of receiving system information from wireless nodes with flexible transmission blocks according to an embodiment of the disclosure. As aforementioned, a transmission of system information between the wireless node and communication devices could be periodic; therefore, the communication device could exploit more periodic transmission blocks to decode the system information, leading to a more accurate decoding result for the system information.

At step 510, a communication device detects more than one set of one or more reference sequences. Each set of the one or more reference sequences from a predefined sequence set indicates time and frequency resource grid of a transmission block for system information. For instance, the communication device could employ a match filter process and other blind or semi-blind detecting algorithms to detect which reference sequence is transmitted from the wireless node. For one example, with respect to the reference sequence and transmission block configuration in FIG. 2, the communication device could detect more than one set of one or more reference sequence on a plurality of subcarriers of at least one set of one or more predefined symbols in corresponding more than one set of one or more subframe groups of the transmission block, and the more than one set of one or more reference sequences corresponds to the more than one set of one or more subframe groups of the transmission block.

For another example, with respect to the reference sequence and transmission block configuration in FIG. 3, the communication device detects more than one set of a starting reference sequence, a middle reference sequence and an ending reference sequence on a plurality of subcarriers of more than one set of one or more predefined symbols in corresponding more than one set of one or more subframe groups of the transmission block, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups.

At step 520, the communication device determines the more than one transmission block for the system information according to the detected more than one set of the one or more reference sequences. As aforementioned, one or more reference sequences indicates the time and frequency resource grid for the transmission block of the system information, as illustrated in FIG. 2 or FIG. 3 for example. Therefore, once the communication device detects more than one set of one ore more reference sequence, it could determine the corresponding more than one transmission blocks itself, since the configuration of reference sequence and transmission block could be preconfigured by the wireless node and communication devices, for example as illustrated in FIG. 2 and FIG. 3.

At step 530, the communication device combines the determined more than one transmission block. For example, the communication device could combine the determined more than one transmission block through a maximum ratio combining (MRC), equal-gain combining (EGC), selecting combining (SC) and other signal combining algorithms, which could be used for the communication devices to increase received signal qualities. Moreover, the combining procedure could be performed with respect to an analog signal level or a soft information level, depending on a specific decoding algorithm implemented in the communication device.

At step 540, the communication device decodes the system information in the combined transmission block. It will be appreciated for the skilled in the art that depending on the specific decoding algorithms used in the communication device, such as MAP decoding algorithm or an iterative Turbo decoding algorithm, the combining step in 530 and decoding step in 540 could be performed as one step, i.e., a joint combining and decoding step, and furthermore the combining step in 530 and decoding step in 540 could be performed in an iterative manner, without departing the spirit of this disclosure.

FIG. 6 schematically illustrates a block diagram of a wireless node according to an embodiment of the disclosure. The wireless node comprises a transmission block determination module configured to determine a transmission block, according to a payload of the system information, a reference sequence determination module configured to determine one or more reference sequences from a predefined sequence set according to the determined transmission block, and the one or more reference sequences indicating time and frequency resource grid of the determined transmission block; and a transmission module configured to transmit the system information and the one or more reference sequences in the determined transmission block.

It should be mentioned the above modules correspond to the steps of the method described in FIG. 1, and it is appreciated for the person skilled in the art that said modules could be implemented via Programmable Logic Device (PLD), Field Programmable Gate Array (FPGA), Application Specific Integrated Circuit (ASIC), and other implement mechanisms as software products, application specific firmware or hardware products.

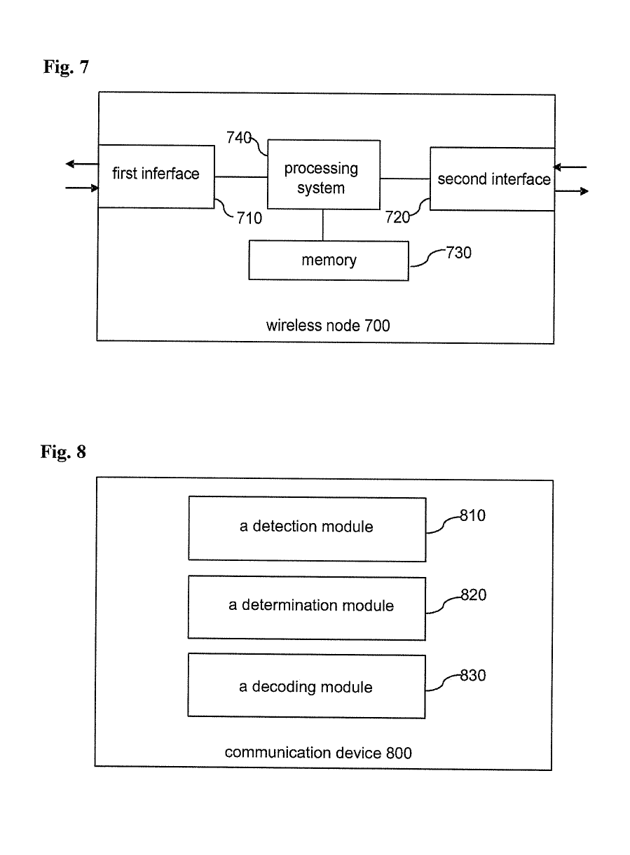

FIG. 7 schematically illustrates another block diagram of a wireless node according to an embodiment of the disclosure. As shown, the wireless node for communication networks comprises a first interface configured to interact with communication devices; a second interface configured to interact with core networks; a memory configured to store data and instructions therein; and a processing system, configured to execute the instructions performing the steps of the method corresponding to FIG. 1.

For example, the memory may include a Read Only Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory includes suitably configured program code to be executed by the processing system so as to implement the above-described functionalities of the wireless node. In particular, the memory may include various program code modules for causing the wireless node to perform processes as described above, e.g., corresponding to the method steps of FIG. 1.

FIG. 8 schematically illustrates a block diagram of a communication device according to an embodiment of the disclosure. As illustrated, the communication device comprises a detection module configured to detect at least one set of one or more reference sequences, each set of the one or more reference sequences from a predefined sequence set indicating time and frequency resource grid of a transmission block for system information, a determination module configured to determine at least one transmission block for the system information according to the detected at least one set of the one or more reference sequences; and a decoding module configured to decode the system information in the determined at least one transmission block.

It should be mentioned the above modules correspond to the steps of the method described in FIG. 4, and it is appreciated for the person skilled in the art that said modules could be implemented via PLD, FPGA, ASIC, and other implement mechanisms as software products, application specific firmware or hardware products.

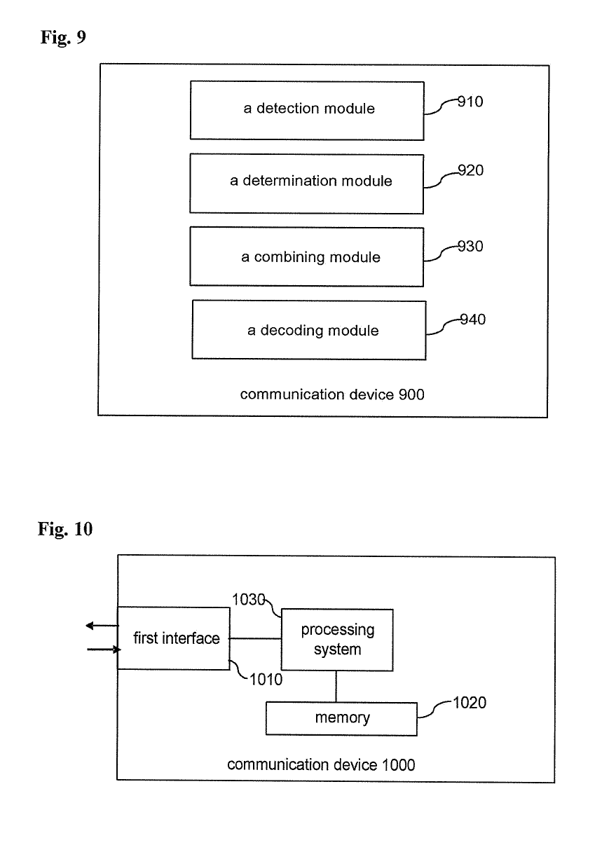

FIG. 9 schematically illustrates another block diagram of a communication device according to an embodiment of the disclosure. If the detection module is configured to detect more than one set of one or more reference sequences, the communication device further comprises a determination module configured to determine the more than one transmission block for the system information according to the detected more than one set of the one or more reference sequences; a combining module configured to combine the determined more than one transmission block and the decoding module configured to decode the system information in the combined transmission block.

It should be mentioned the above modules correspond to the steps of the method described in FIG. 5, and it is appreciated for the person skilled in the art that said modules could be implemented via PLD, FPGA, ASIC, and other implement mechanism as software products, application specific firmware or hardware products.

FIG. 10 schematically illustrates another block diagram of a communication device according to an embodiment of the disclosure. The communication device may for example correspond to user equipment, such as mobile, smart phone, tablet and notebook etc. The communication device operable in communication networks comprises a first interface configured to interact with communication networks, a memory configured to store data and instructions therein; and a processing system, configured to execute the instructions performing the steps of the method in FIG. 4-5.

For example, the memory may include a ROM, e.g., a flash ROM, a RAM, e.g., a DRAM or SRAM, a mass storage, e.g., a hard disk or solid state disk, or the like. The memory includes suitably configured program code to be executed by the processing system so as to implement the above-described functionalities of the communication device. In particular, the memory may include various program code modules for causing the communication device to perform processes as described above, e.g., corresponding to the method steps of FIG. 4-5.

It should be appreciated that the above concepts may be implemented by using correspondingly designed software to be executed by one or more processors of an existing device, or by using dedicated device hardware. Further, it should be noted that the illustrated nodes or devices may each be implemented as a single node or device or as a system of multiple interacting nodes or devices.

While the embodiments have been illustrated and described herein, it will be understood by those skilled in the art that various changes and modifications may be made, and equivalents may be substituted for elements thereof without departing from the scope of the present technology. In addition, many modifications may be made to adapt to a particular situation and the teaching herein without departing from its scope. Therefore it is intended that the present embodiments not be limited to the particular embodiment disclosed, but that the present embodiments include all embodiments falling within the scope of the appended claims.

1-3. (canceled)

4. A method for a communication device receiving system information in communication networks, the method comprising:
detecting at least one set of one or more reference sequences, each set of the one or more reference sequences from a predefined sequence set indicating time and frequency resource grid of a transmission block for system information;
determining at least one transmission block for the system information according to the detected at least one set of the one or more reference sequences; and
decoding the system information in the determined at least one transmission block.

5. The method of claim 4, wherein
detecting the at least one set of reference sequences comprises detecting a first set of reference sequences and detecting a second set of reference sequences, and
the method further comprises:
determining the more than one transmission block for the system information according to the detected more than one set of the one or more reference sequences;
combining the determined more than one transmission block; and
decoding the system information in the combined transmission block.

6. The method of claim 4, wherein detecting at least one set of one or more reference sequences further comprising detecting at least one set of one or more reference sequence on a plurality of subcarriers of at least one set of one or more predefined symbols in corresponding at least one set of one or more subframe groups of the transmission block, the at least one set of one or more reference sequences corresponding to the at least one set of one or more subframe groups of the transmission block.

7. The method of claim 4, wherein detecting at least one set of one or more reference sequences further comprising detecting at least one set of a starting reference sequence, a middle reference sequence and an ending reference sequence on a plurality of subcarriers of at least one set of one or more predefined symbols in corresponding at least one set of one or more subframe groups of the transmission block, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups.

8-18. (canceled)

19. A wireless node in communication networks, the wireless node comprising:
a memory configured to store data and instructions therein, and
a processor configured to execute the instructions to:
determine a transmission block, according to a payload of the system information;
determine one or more reference sequences from a predefined sequence set according to the determined transmission block, the one or more reference sequences indicating time and frequency resource grid of the determined transmission block; and
transmit the system information and the one or more reference sequences in the determined transmission block.

20. The wireless node of claim 19, wherein the determined transmission block comprising one or more subframe groups and a plurality of subcarriers, the one or more reference sequences corresponding to the one or more subframe groups of the determined transmission block, and each reference sequence of the one or more reference sequences is transmitted on the plurality of subcarriers of a predefined symbol in the corresponding subframe group.

21. The wireless node of claim 19, wherein the determined transmission block comprising one or more subframe groups and a plurality of subcarriers, the determined reference sequences from the predefined sequence set comprising a starting reference sequence, a middle reference sequence and an ending reference sequence, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups, and each reference sequence of the one or more reference sequences is transmitted on the plurality of subcarriers of a predefined symbol in the corresponding subframe group.

22. A communication device for receiving system information in communication networks, comprising:
a memory configured to store data and instructions therein; and
a processor configured to execute the instructions in the memory to:
detect at least one set of one or more reference sequences, each set of the one or more reference sequences from a predefined sequence set indicating time and frequency resource grid of a transmission block for system information;
determine at least one transmission block for the system information according to the detected at least one set of the one or more reference sequences; and
decode the system information in the determined at least one transmission block.

23. The communication device of claim 22, the communication device is further configured to:
if more than one set of one or more reference sequences are detected, determine the more than one transmission block for the system information according to the detected more than one set of the one or more reference sequences;
combine the determined more than one transmission block; and
decode the system information in the combined transmission block.

24. The communication device of claim 22, the communication device is configured to:
detect at least one set of one or more reference sequence on a plurality of subcarriers of at least one set of one or more predefined symbols in corresponding at least one set of one or more subframe groups of the transmission block, the at least one set of one or more reference sequences corresponding to the at least one set of one or more subframe groups of the transmission block.

25. The communication device of claim 22, the communication device is configured to:
detect at least one set of a starting reference sequence, a middle reference sequence and an ending reference sequence on a plurality of subcarriers of at least one set of one or more predefined symbols in corresponding at least one set of one or more subframe groups of the transmission block, the starting reference sequence corresponding to a first subframe group of the one or more subframe groups, the ending reference sequence corresponding to a last subframe group of the one or more subframe groups, and the middle reference sequence corresponding to other subframe groups of the one or more subframe groups than the first subframe group and the last subframe group of the one or more subframe groups.
